(19) United States
(12) Patent Application Publication
(10) Pub. No.: US 2026/0233970 A1
(43) Pub. Date: Aug. 13, 2026

(54) MANAGEMENT SYSTEM FOR ELEVATORS

(71) Applicant: Mitsubishi Electric Building Solutions Corporation, Tokyo (JP)

(72) Inventors: Kazufumi HIRABAYASHI, Tokyo (JP); Takuya MIURA, Tokyo (JP)

(73) Assignee: Mitsubishi Electric Building Solutions Corporation, Tokyo (JP)

(21) Appl. No.: 19/153,347

(22) PCT Filed: Apr. 4, 2023
(86) PCT No.: PCT/JP2023/013951

§ 371 Date: Aug. 4, 2025

(51) Int. Cl. B66B 5/00

(52) U.S. Cl. CPC B66B 5/0037; B66B 5/0025

(57) ABSTRACT

A management system includes: a monitoring device installed in a facility to which an elevator is applied; and an analysis device connected to the monitoring device through a first communication network. In the analysis device, a first server-side communication unit receives, from the monitoring device, operation data indicating a situation of an operation of the elevator. A reproduction unit reproduces, based on a working model, working data indicating a situation of working of the elevator during the operation indicated by the operation data. Using the reproduced working data, the evaluation unit evaluates, based on a deterioration factor model, a deterioration factor affecting deterioration of equipment of the elevator during the operation indicated by the operation data. Using the evaluated deterioration factor, the judgment unit judges a remaining lifespan of the equipment, based on a lifespan model.

### TECHNICAL FIELD

The present disclosure relates to a management system for elevators.

### BACKGROUND ART

PTL 1 discloses an example of an elevator/escalator maintenance device for an elevator or the like. The maintenance device includes part lifespan analysis and setting means for performing lifespan analysis and setting of parts. The maintenance device includes maintenance work setting means for setting a part replacement cycle and an inspection cycle. The maintenance device includes in-service data collection means for collecting in-service data on the elevator or escalator.

### CITATION LIST

### Patent Literature

[PTL 1] JP 2003-238041 A

### SUMMARY OF THE INVENTION

### Problem to be Solved by the Invention

In the elevator/escalator maintenance device of PTL 1, the in-service data includes data such as loads on parts, environmental temperature, humidity, motion speed, and the number of rotations. The maintenance device performs processing, such as the lifespan analysis, by using the in-service data collected from each elevator or each escalator via a wide-area communication network, such as the Internet. Here, when time-series data or the like on the speed of a car and the number of rotations and the current of a motor, which indicate a situation of working of equipment of an elevator, an escalator, or the like, is used for in-service data in order to perform the lifespan analysis and the like with higher accuracy, the volume of communication through the wide-area communication network can be enormous.

The present disclosure relates to a solution to such a problem. The present disclosure provides a management system that can reduce the volume of communication through a communication network, for information that is used to evaluate the life of equipment of an elevator.

### Means to Solve the Problem

A management system according to the present disclosure includes: a monitoring device that is installed in a facility to which an elevator is applied, and that monitors a situation of the elevator; and an analysis device connected to the monitoring device through a first communication network, wherein the analysis device includes a reception unit that receives operation data from the monitoring device through the first communication network, the operation data indicating a situation of an operation of the elevator, a reproduction unit that reproduces working data based on a working model of the elevator by using the operation data received by the reception unit, the working data indicating a situation of working of the elevator during the operation indicated by the operation data; an evaluation unit that evaluates a deterioration factor based on a deterioration factor model of equipment of the elevator by using the working data reproduced by the reproduction unit, the deterioration factor affecting deterioration of the equipment during the operation indicated by the operation data; and a judgment unit that judges a remaining lifespan of the equipment of the elevator based on a lifespan model of the equipment by using the deterioration factor of the equipment evaluated by the evaluation unit.

### Advantageous Effect of the Invention

With the management system according to the present disclosure, for information that is used to evaluate the life of equipment of an elevator, the volume of communication through a communication network is reduced.

### BRIEF DESCRIPTION OF DRAWINGS

FIG. 1 is a configuration diagram of a management system according to Embodiment 1.

FIG. 2 is a flowchart showing the example of operation of the management system according to Embodiment 1.

FIG. 3 is a hardware configuration diagram of main parts of the management system according to Embodiment 1.

### DESCRIPTION OF EMBODIMENT

An embodiment for carrying out a subject of the present disclosure is described with reference to the accompanying drawings. Throughout the drawings, the same or corresponding parts are denoted by the same reference signs, and a duplicate description is simplified or omitted as appropriate. Note that the subject of the present disclosure is not limited to the embodiment described below, and deformation of any constituent element of the embodiment, or omission of any constituent element of the embodiment, can be made within the scope that does not depart from the gist of the present disclosure.

### Embodiment 1

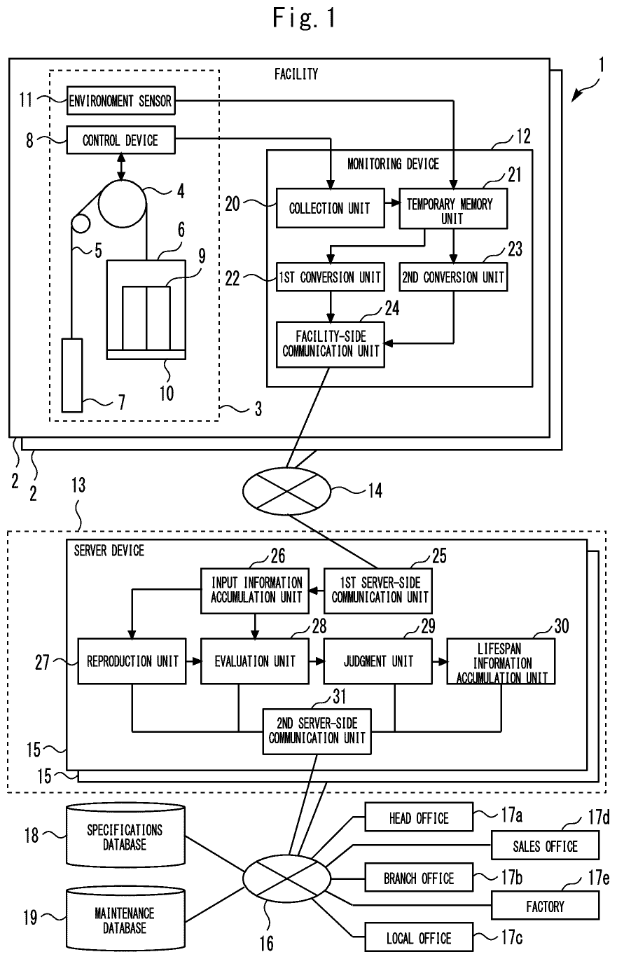

FIG. 1 is a configuration diagram of a management system 1 according to Embodiment 1.

The management system 1 is a system that manages an elevator. The elevator is applied to a facility 2 having a plurality of floors. The facility 2 to which the elevator is applied includes, for example, one or more buildings. The facility 2 to which the elevator is applied may be part of a building. The facility 2 to which the elevator is applied may be any one of an indoor facility and an outdoor facility. The management system 1 may manage a plurality of elevators. At the time, the management system 1 may manage the plurality of elevators applied to the same facility 2, or may manage the plurality of elevators applied to different facilities 2 from each other.

In the facility 2 to which the elevator is applied, a hoistway 3 of the elevator is provided. The hoistway 3 is a space elongated in up-down directions across the plurality of floors of the facility 2. The elevator includes a traction machine 4, a main rope 5, a car 6, a counterweight 7, and a control device 8.

The traction machine 4 includes a sheave. The traction machine 4 is a device having a function of generating torque that causes the sheave to rotate. For example, the traction machine 4 includes a motor that generates the torque. For example, the traction machine 4 is installed in an upper portion or a lower portion of the hoistway 3, or the like. When a machine room is provided above the hoistway 3 or the like, the traction machine 4 may be installed in the machine room.

The main rope 5 is passed over the sheave of the traction machine 4. The main rope 5 supports the load of the car 6 by suspending the car 6 in the hoistway 3. The main rope 5 supports the load of the counterweight 7 by suspending the counterweight 7 in the hoistway 3. For example, the main rope 5 may be a stranded rope, a belt rope, or the like.

The car 6 and the counterweight 7 run in the opposite directions to each other in the hoistway 3, as a result of the main rope 5 moving due to rotation of the sheave of the traction machine 4. The car 6 is equipment that transports a passenger or the like between a plurality of floors by running in the up-down directions inside the hoistway 3. The counterweight 7 is equipment to maintain a balance, with the car 6, of the loads applied to the main rope 5 on both sides of the sheave of the traction machine 4. The car 6 and the counterweight 7 run in the up-down directions inside the hoistway 3, for example, by being guided by an undepicted guide rail or the like. The car 6 includes a car door 9 and a load weighing device 10. The car door 9 includes a door panel that serves as a demarcation between the inside and the outside of the car 6, and a motor that causes the door panel to open and close. The load weighing device 10 is a device that measures a car load produced by the loads of a user and the like aboard the car 6.

The control device 8 is equipment that controls the motion of the elevator. For example, the control device 8 is installed in an upper portion or a lower portion of the hoistway 3, or the like. When a machine room is provided above the hoistway 3 or the like, the control device 8 may be installed in the machine room. For example, the control device 8 controls running and the like of the car 6 in response to a call from a user. In the present example, running of the car 6 from departing from a departure floor until stopping at a destination floor is assumed to be one run of the car 6. For example, the control device 8 controls opening and closing and the like of the car door 9 of the car 6 of the elevator. In the present example, a series of motions of the car door 9 starting from a full-close condition, fully opening through an opening motion, waiting in a full-open condition, until fully closing through a closing motion is assumed to be one open-and-close of the car door 9.

The control device 8 keeps control information related to control of the elevator. The control information includes a parameter or the like causally related to one or both of transitional heating-up or cooling of each item of equipment included in the elevator. The parameter may be one having continuous values, or one having discrete values, or may be one indicating any one of a plurality of selections, or the like. The control information includes noncontinuous values representing the condition or the like of the elevator, such as an inverter drive instruction signal, a fan drive instruction signal, a door open instruction signal, a door close instruction signal, a door full-open recognition signal, a door full-close recognition signal, and a landing plate information. Here, an inverter is, for example, a device that outputs drive current to the motor of the traction machine 4, or the like. A fan is, for example, a device that sends wind to air-cooling equipment or the like included in the elevator, or the like. The control information includes continuous or discrete numerical value information, such as time-of-day information, information on a floor where the car 6 is landed, information on an absolute position or a relative position of the car 6 in the hoistway 3, a car load, a car running speed instruction value, a traction machine motor speed instruction value, a traction machine motor speed feedback value, a traction machine motor current instruction value, a traction machine motor current feedback value, a traction machine motor voltage instruction value, a door opening motion start time, door full-open wait time, a door closing motion completion time, a door speed instruction value, a door speed feedback value, a door opening-and-closing motor current instruction value, a door opening-and-closing motor current feedback value, and a door opening-and-closing motor voltage instruction value.

To the elevator, an environment sensor 11 is applied. The environment sensor 11 is a device that acquires data on a working environment of the elevator. For example, the environment sensor 11 is installed in the hoistway 3 of the elevator, the machine room for the elevator, or the like. It is preferable that the environment sensor 11 be installed at a place where the effect of local heat generated by equipment included in the elevator is small, such as in a lower portion of the control device 8. For example, the environment sensor 11 includes one or both of a temperature sensor and a humidity sensor. For the elevator, a plurality of environment sensors 11 may be provided.

The management system 1 includes a monitoring device 12 and an analysis device 13.

The monitoring device 12 is provided correspondingly to the elevator managed by the management system 1. When the management system 1 manages a plurality of elevators, the management system 1 may include a plurality of management devices. At the time, each elevator is supported by any one of the management devices. The monitoring device 12 is installed in the facility 2 to which the corresponding elevator is applied. The monitoring device 12 acquires information on the corresponding elevator, for example, from the control device 8 of the elevator, the environment sensor 11 that acquires data on the working environment of the elevator, and the like, and thereby monitors a situation of the elevator. The monitoring device 12 is connected to the analysis device 13 through a wide-area first communication network 14, such as the Internet. The first communication network 14 may be a VPN (Virtual Private Network) configured on a public network such as the Internet, or any other secure network or the like. For example, the monitoring device 12 is an edge server or the like. The monitoring device 12 transmits operation data indicating a situation of an operation of the elevator to the analysis device 13 via the first communication network 14.

Here, the operation data is, for example, information or the like that typically indicates each one operation of the elevator, such as one run of the car 6 and one open-and-close of the car door 9. In the present example, the operation data does not include time-series data that indicates continuous changes over time in numerical value of physical quantities and the like including speed and current, in the form of a series of the numerical values at individual time points. Here, operation data on running of the car 6 in the up-down directions in each run is referred to as car running basic information, in some cases. Operation data on opening and closing of the car door 9 in each open-and-close is referred to as car door opening-and-closing basic information, in some cases. In the present example, the operation data includes the car running basic information and the car door opening-and-closing basic information.

For example, the car running basic information includes a start time of a run of the car 6, a departure floor of the car 6 or the position of the car 6 in the hoistway 3 at a time of departure, an arrival floor of the car 6 or the position of the car 6 in the hoistway 3 at a time of arrival, a time of completion of the run of the car 6, and a car load. The car running basic information may omit to include any information among the above. For example, the car running basic information may omit to include one of the start time of a run of the car 6 and the time of completion of the run of the car 6.

For example, the car door opening-and-closing basic information includes a floor on which the car door 9 opens and closes, a start time of an opening motion of the car door 9, wait time for which the car door 9 stays in the full-open condition, and a time of completion of a closing motion of the car door 9. The car door opening-and-closing basic information may omit to include any information among the above. For example, the car door opening-and-closing basic information may omit to include one of the start time of an opening motion of the car door 9 and the time of completion of a closing motion of the car door 9. The car door opening-and-closing basic information may include the number of door reversals of the car door 9.

Note that with regard to running of the car 6 and opening and closing of the car door 9, the operation data may include information on an operation mode of the elevator, for example, when the elevator is equipped with an operation mode for wheelchair users, or the like.

The analysis device 13 is a device that performs information processing and the like for the elevator that is managed by the management system 1. For example, the analysis device 13 is a computer system or the like including one or more server devices 15. The analysis device 13 may include three or more server devices 15. The analysis device 13 may have a multiple configuration including a plurality of server devices 15 having the same functionality. One or some, or all, of the server devices 15 included in the analysis device 13 are installed at a place remote from the facility 2 to which the elevator supported by the monitoring device 12 is applied. The analysis device 13 may be installed in a country, a region, or the like that is different from that of the facility 2 to which the elevator supported by the monitoring device 12 is applied. When the analysis device 13 includes a plurality of server devices 15, one or some of the server devices 15 may be installed in a country, a region, or the like that is different from that of the other server devices 15. When the analysis device 13 includes a plurality of server devices 15, the individual server devices 15 are connected to each other, for example, through the first communication network 14. For example, part or the whole of the functionality of the analysis device 13 may be mounted on an on-premises server of a maintenance company that operates the management system 1, or may be mounted on a cloud server. Part or the whole of the functionality of the analysis device 13 may be implemented through processing on a cloud service or by a resource in memory.

The analysis device 13 is connected to an internal second communication network 16, such as an intranet or a private network of the maintenance company. For example, in cases such as where the analysis device 13 is configured by using a cloud server, the second communication network 16 may be a VPN configured on a public network such as the Internet. A user allowed to access the second communication network 16 is set in the management system 1. Note that an access right of a user may be granted to the user, may be granted to a group to which the user belongs, or may be granted to a role assigned to the user. For example, a group to which a user belongs may be a group of sites of the maintenance company, such as a head office 17a, a branch office 17b, a local office 17c, a sales office 17d, and a factory 17e, or may be a group of other organizations of the maintenance company, such as technical departments, or the like.

The second communication network 16 is a network through which the specifications database 18 and the maintenance database 19 are accessible. For example, part or the whole of the specifications database 18 and the maintenance database 19 is mounted on an on-premises server of the maintenance company, a cloud server, or the like. Part or the whole of the specifications database 18 and the maintenance database 19 may be mounted on the analysis device 13.

The specifications database 18 is a database that stores specifications information on the elevator. The specifications database 18 stores identification information for identifying the elevator that is managed by the management system 1 and the specifications information on the elevator in association with each other. For example, the specifications information on the elevator may include a control method for the elevator, the model name of the traction machine 4 of the elevator, the model name of the control device 8 of the elevator, a rated speed, a rated load, an elevating stroke, the model name of the car door 9, and the like. The specifications information on the elevator may include information on the height of each floor of the facility 2 to which the elevator is applied, or the like.

The maintenance database 19 is a database that stores maintenance information on the elevator. The maintenance database 19 stores the identification information for identifying the elevator that is managed by the management system 1 and the maintenance information on the elevator in association with each other. For example, the maintenance information on the elevator includes information on a service start date on which an elevator service of the elevator is started after installation, parts replacement history, and the like.

The monitoring device 12 includes a collection unit 20, a temporary memory unit 21, a first conversion unit 22, a second conversion unit 23, and a facility-side communication unit 24. Part or the whole of the functionality of the monitoring device 12 may be mounted on equipment of the supported elevator, such as the control device 8.

The collection unit 20 is a part having a function of collecting information from the control device 8 of the elevator, the environment sensor 11, and the like. For example, the collection unit 20 collects control information or the like from the control device 8 of the elevator. The collection unit 20 may acquire detailed information, such as time-series data, as the control information. The collection unit 20 collects data on the working environment from the environment sensor 11. The collection unit 20 may collect information on a time of collection of the information together. The collection unit 20 outputs the collected information to the temporary memory unit 21.

The temporary memory unit 21 is a part having a function of temporarily storing the information collected by the collection unit 20. The temporary memory unit 21 stores the information collected by the collection unit 20 from the control device 8 of the elevator and the information collected by the collection unit 20 from the environment sensor 11 in association with each other based on the information on the time of collection.

The first conversion unit 22 is a part having a function of extracting information from data collected from the elevator and converting the information into operation data. The first conversion unit 22 reads, from the temporary memory unit 21, information collected by the collection unit 20 and performs conversion. For example, the first conversion unit 22 extracts car running basic information, such as a departure floor and an arrival floor of the car 6, from time-series data on the position, speed, or acceleration of the car 6, or the like. For example, the first conversion unit 22 extracts car door opening-and-closing basic information, such as a start time of an opening motion and a time of completion of a closing motion of the car door 9, from time-series data on the opening degree of the door panel of the car door 9, or the like. The first conversion unit 22 generates operation data on the elevator by using the extracted information. The first conversion unit 22 may perform the conversion into operation data successively each time the above-mentioned data is collected from data collected from the elevator, or may perform the conversion into operation data at a preset regular timing or an irregular timing. The first conversion unit 22 outputs the operation data obtained by the conversion to the facility-side communication unit 24.

The second conversion unit 23 is a part having a function of resampling part of data on the working environment collected from the environment sensor 11 or the like, and converting the resampled data together with the operation data into communicable data. The second conversion unit 23 reads, from the temporary memory unit 21, information collected by the collection unit 20 and performs conversion. For example, the second conversion unit 23 resamples data on the working environment read from the temporary memory unit 21 to obtain temperature and humidity information in each preset period. In the present example, a sampling rate after the resampling by the second conversion unit 23 is lower than an original sampling rate for the data on the working environment collected by the collection unit 20. The second conversion unit 23 may successively perform the conversion by resampling, or may perform the conversion by resampling at a preset regular timing or an irregular timing. The second conversion unit 23 outputs data on the working environment obtained by the conversion by resampling to the facility-side communication unit 24.

The facility-side communication unit 24 is a part having a function of communicating information through the first communication network 14. The facility-side communication unit 24 transmits the operation data from the first conversion unit 22 to the analysis device 13 through the first communication network 14. In the present example, the facility-side communication unit 24 transmits the operation data from the first conversion unit 22 and the data on the working environment from the second conversion unit 23 together, in association with each other, to the analysis device 13 through the first communication network 14. The facility-side communication unit 24 is an example of a transmission unit.

The facility-side communication unit 24 performs the transmission of the operation data and the data on the working environment, with one or both of a processing load on the analysis device 13 or a communication load on the first communication network 14 taken into consideration. For example, the facility-side communication unit 24 performs the transmission of the data in hours of the day during which the elevator less frequently operates, such as in the night. For example, the facility-side communication unit 24 may attempt to prevent the processing load from being concentrated on the analysis device 13 by transmitting the data based on schedule management on the analysis device 13 side. For example, the facility-side communication unit 24 may send an inquiry to the analysis device 13 about the processing load and determine a timing of transmitting the data, based on an answerback from the analysis device 13. For example, the facility-side communication unit 24 may transmit the data to the analysis device 13 when receiving a regular or irregular polling trigger sent out from the analysis device 13. For example, the facility-side communication unit 24 may temporarily stop transmitting the data when the communication load on the first communication network 14 is heavy. Note that monitoring of the communication load on the first communication network 14 may be performed any of the monitoring device 12 and the analysis device 13.

The analysis device 13 includes a first server-side communication unit 25, an input information accumulation unit 26, a reproduction unit 27, an evaluation unit 28, a judgment unit 29, a lifespan information accumulation unit 30, and a second server-side communication unit 31.

The first server-side communication unit 25 is a part having a function of communicating information through the first communication network 14. The first server-side communication unit 25 receives the operation data transmitted from the facility-side communication unit 24 through the first communication network 14. In the present example, the first server-side communication unit 25 receives, through the first communication network 14, both the operation data on the elevator and the data on the working environment that are associated with each other. The facility-side communication unit 24 is an example of a reception unit. The first server-side communication unit 25 outputs the received information to the input information accumulation unit 26.

The input information accumulation unit 26 is a part having a function of accumulating information. The input information accumulation unit 26 classifies, accumulates, and stores, by target elevator, the operation data on an elevator and the data on the working environment received by the first server-side communication unit 25. Since the operation data transmitted from the monitoring device 12 has a small data quantity for each one operation, the input information accumulation unit 26 may accumulate the information in such a manner as to keep history of the lifetime of each elevator over the entire service duration since the elevator service started.

The reproduction unit 27 is a part having a function of reproducing working data indicating a situation of working of the elevator when an operation indicated by the operation data is performed, based on a working model of the elevator. For example, the working data is data that concretely reproduces kinetic, dynamic, or electromagnetic physical quantities, such as a speed, a current, and the like in each one operation of the elevator. Here, a physical quantity in the working data may be an instruction value, a feedback value, or the like, as well as an actually realized value, of the quantity, such as the speed of the car 6 or the current of a motor. For example, the current of a motor in the working data may have values of components obtained by coordinate transformation into d-axis current and q-axis current, and the like. In the present example, the working data is data that indicates a situation of working of the elevator, such as running of the car 6 and opening and closing of the car door 9, in more detail than the operation data. The working data may include time-series data that indicates continuous changes over time in numerical value of physical quantities and the like including speed and current, in the form of a series of the numerical values at individual time-or-day points. For example, the working data includes time-series data on the running speed of the car 6, the current of the motor for the traction machine, the voltage of the motor for the traction machine, and the like. For example, the working data includes time-series data on the opening and closing speed of the car door 9, the current of the motor for door opening and closing, the voltage of the motor for door opening and closing, and the like. The reproduction unit 27 reads the operation data accumulated in the input information accumulation unit 26 and reproduces the working data. The reproduction unit 27 reproduces the working data, based on the preset working model of the elevator. For example, the working model of the elevator is a physical model created by modeling kinetic, dynamic, or electromagnetic characteristics and the like of the elevator. The reproduction unit 27 may reproduce working data successively each time the first server-side communication unit 25 receives operation data and the like from the monitoring device 12, or may perform conversion of accumulated operation data and the like into working data at a preset regular timing or an irregular timing. The reproduction unit 27 outputs the reproduced working data to the evaluation unit 28.

The evaluation unit 28 is a part having a function of evaluating a deterioration factor that affects deterioration of equipment of the elevator during an operation of the elevator. The evaluation unit 28 evaluates the deterioration factor during an operation of the elevator indicated by the operation data received from the monitoring device 12. The evaluation unit 28 performs evaluation, based on a preset deterioration factor model, by using the working data reproduced by the reproduction unit 27 and the data on the working environment read from the input information accumulation unit 26. Since deterioration mechanisms vary from equipment to equipment of the elevator, deterioration factors vary from equipment to equipment of the elevator. Accordingly, when deterioration factors are evaluated for a plurality of items of equipment of the elevator, the evaluation unit 28 may evaluate the respective deterioration factors for the items of equipment, by using a plurality of deterioration factor models.

For example, with regard to equipment that deteriorates due to a temperature-dependent mechanism such as the Arrhenius equation, or thermal expansion in connection with heating or cooling, or the like, a deterioration factor may be the temperature of the equipment, or time-series data or the like on the temperature. For example, deterioration factors may include the temperature of equipment such as the control device 8 or the traction machine 4. For example, deterioration factors may include the magnet temperature and the winding coil temperature of a permanent-magnet motor, bearing temperature, the chip temperature and the case temperature of a power semiconductor, electrolytic capacitor temperature, battery temperature, or the like. When a deterioration factor is temperature, a deterioration factor model may be a thermal model, such as a thermal circuit model. At the time, the thermal model may be a model that factors in heating-up or cooling due to working of the equipment of the elevator. For example, the heating-up or cooling due to working of the equipment of the elevator may include Joule heating by current, air-cooling by working of a fan, or the like. A heating value or a cooling value due to working of the equipment of the elevator is estimated, for example, based on a value of current or the like in the reproduced working data.

With regard to equipment in which bending fatigue can occur, such as the main rope 5 of the elevator, a deterioration factor may be information on a bending or the like occurring in the equipment. For example, the information on a bending includes information on the size, direction, frequency, and the like of the bending. The information on a bending is estimated, for example, based on a running position of the car 6, a car load, and the like in the reproduced working data.

With regard to equipment with electrical contacts that are mechanically opened and closed, such as an electromagnetic contactor, a deterioration factor may be the number of open-and-closes. The number of open-and-closes of an electromagnetic contactor is estimated, for example, based on the number of runs of the elevator in the reproduced working data, as well as an excitation duration, excitation current, and the like.

The judgment unit 29 is a part having a function of judging the remaining lifespan of equipment of the elevator. By using the deterioration factor of equipment of the elevator evaluated by the evaluation unit 28, the judgment unit 29 judges the remaining lifespan of the equipment, based on a lifespan model of the equipment. The judgment unit 29 may perform remaining lifespan judgement for each of a plurality of items of equipment. The lifespan model includes a model, for example, based on the Arrhenius equation or the like, that associates the remaining lifespan, or a lifespan consumption rate indicating the rate or the like at which deterioration progresses, with the deterioration factor such as temperature. For example, the judgment unit 29 judges the remaining lifespan of target equipment by comparing data related to a relation between a lifespan presented by the manufacturer or the like of the equipment and the deterioration factor, to the deterioration factor evaluated by the evaluation unit 28. For example, the judgment unit 29 may judge the remaining lifespan of the equipment by comparing the deterioration factor in service history of the same type of equipment to the deterioration factor evaluated by the evaluation unit 28. For example, the remaining lifespan is a numerical value indicating what percentages of lifespan has been consumed in the current condition, assuming that a brand-new condition of the equipment beginning to be used is 100%, and a condition in which the product cycle has completed is 0%. The judgment unit 29 may predict a transition of the remaining lifespan of the equipment. For example, the transition of the remaining lifespan of the equipment is estimated based on history of past uses of the equipment, or the like. The judgment unit 29 may judge a time at which the equipment completes the product cycle, based on a result of the prediction of the transition of the remaining lifespan. The judgment unit 29 outputs results of the judgement, such as the remaining lifespan of the target equipment and the time at which the target equipment completes the product cycle, to the lifespan information accumulation unit 30.

The lifespan information accumulation unit 30 is a part having a function of storing, in an accumulating manner, results of the judgment by the judgment unit 29. In the present example, the lifespan information accumulation unit 30 stores, in an accumulating manner, information on the remaining lifespan judged by the judgment unit 29 over the entire service duration since the elevator service started. At the time, with regard to equipment of the elevator, the lifespan information accumulation unit 30 stores a result of the judgment on the remaining lifespan in each service period, that is, the transition of the remaining lifespan. A remaining lifespan accumulation unit stores identification information for identifying the elevator managed by the management system 1, information for identifying the judged equipment of the elevator, and a result of the judgment on the equipment in association with each other. The remaining lifespan accumulation unit may also store a result of the deterioration factor evaluation on the equipment together.

The second server-side communication unit 31 is a part having a function of communicating information through the second communication network 16. The analysis device 13 accesses the specifications database, the maintenance database 19, and the like via the second server-side communication unit 31. In working data reproduction, deterioration factor evaluation, remaining lifespan judgment, and the like, the analysis device 13 may use specifications information read from the specifications database. The analysis device 13 may write a result of the remaining lifespan judgment and the like in maintenance information in the maintenance database 19.

The analysis device 13 may grant a user who is allowed to access the second communication network 16 one or some, or all, of an access right to browse the information accumulated in the lifespan information accumulation unit 30, an access right to update the working model used by the reproduction unit 27, an access right to update the deterioration factor model used by the evaluation unit 28, and an access right to update the lifespan model used by the judgment unit 29. The analysis device 13 may set granting of an access right for each user, each group, or each role individually. The analysis device 13 may change existence or absence and a type of an access right that is granted beforehand. For example, the analysis device 13 grants users of the factory 17e the access right to browse the information accumulated in the lifespan information accumulation unit 30, the access right to update the working model, the access right to update the deterioration factor model, and the access right to update the lifespan model. For example, the analysis device 13 grants users of the sales office 17d the access right to browse the information accumulated in the lifespan information accumulation unit 30.

A user who is allowed to access the second communication network 16 or the analysis device 13 performs maintenance determination, such as replacement judgment on equipment of the elevator, based on a result of the remaining lifespan judgment and the like. For example, the replacement judgment may be performed by the analysis device 13, based on a criterion preset for remaining lifespan or the like. More specifically, for example, when the remaining lifespan judged by the judgment unit 29 is lower than a remaining lifespan-based replacement criterion that is preset for each equipment, it is judged to be time to replace the equipment. For example, the replacement judgment may be performed by maintenance personnel in charge of maintenance of the elevator. More specifically, for example, the maintenance personnel in charge determines necessity of replacing equipment or the like, with a result of the remaining lifespan judgment on the elevator and a future maintenance plan taken into consideration. For example, the replacement judgment may be performed by the analysis device 13, based on a relative comparison with another elevator or the like. For example, with regard to equipment with a limited number of supplies, it may be determined which elevator is given a higher priority in replacement of the equipment. At the time, for example, the analysis device 13 sorts similar types of elevators in ascending order of the remaining lifespan of the equipment, whereby a piece of the equipment having a shorter remaining lifespan can be more preferentially replaced. Through such maintenance determination, arrangement of matters to be handled beforehand, such as supply of equipment to be replaced and adjustment of a schedule for replacement work, is made easier.

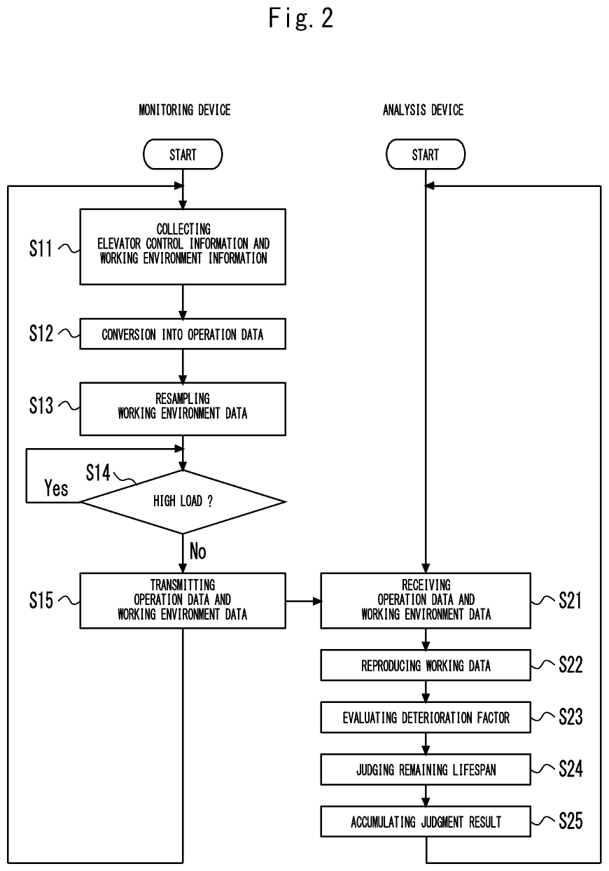

Subsequently, an example of operation of the management system 1 is described, using FIG. 2.

FIG. 2 is a flowchart showing the example of operation of the management system 1 according to Embodiment 1.

In step S11, the collection unit 20 of the monitoring device 12 collects control information on an elevator and information on a working environment thereof. Thereafter, in step S12, the first conversion unit 22 converts the collected information into operation data. Thereafter, in step S13, the second conversion unit 23 performs resampling of the collected information on the working environment. Thereafter, in step S14, the facility-side communication unit 24 judges whether the processing load on the analysis device 13 or the communication load on the first communication network 14 is a heavy load. When a heavy load is judged, the processing by the monitoring device 12 moves to step S14 again. When a non-heavy load is judged, the processing by the monitoring device 12 moves to step S15. In step S15, the facility-side communication unit 24 transmits the operation data and the resampled data on the working environment together to the analysis device 13. Thereafter, the processing by the monitoring device 12 moves to step S11.

In step S21, the first server-side communication unit 25 of the analysis device 13 receives the operation data and the resampled data on the working environment together from the monitoring device 12. Thereafter, in step S22, the reproduction unit 27 reproduces working data from the operation data, based on the working model. Thereafter, in step S23, the evaluation unit 28 evaluates a deterioration factor of equipment of the elevator from the working data and the data on the working environment, based on the deterioration factor model of the equipment. Thereafter, in step S24, the judgment unit 29 evaluates the remaining lifespan of the equipment of the elevator from the deterioration factor of the equipment. Thereafter, in step S25, the lifespan information accumulation unit 30 stores, in an accumulating manner, a result of the judgment on the remaining lifespan made by the judgment unit 29. Thereafter, the processing by the analysis device 13 moves to step S21.

Note that the monitoring device 12 may collect working data from the control device 8 of the elevator or the like. At the time, the first conversion unit 22 converts the collected working data into operation data so that the load of communication through the first communication network 14 can be reduced. The monitoring device 12 may collect operation data from the control device 8 of the elevator or the like. At the time, the monitoring device 12 may transmit the collected operation data to the analysis device 13 without conversion. The analysis device 13 reproduces working data from the collected operation data, based on the working model.

As described hereinabove, the management system 1 according to the embodiment 1 includes the monitoring device 12 and the analysis device 13. The monitoring device 12 is installed in the facility 2 to which an elevator is applied. The monitoring device 12 monitors a situation of the elevator. The analysis device 13 is connected to the monitoring device 12 through the first communication network 14. The analysis device 13 includes the first server-side communication unit 25, the reproduction unit 27, the evaluation unit 28, and the judgment unit 29. The first server-side communication unit 25 receives operation data indicating a situation of an operation of the elevator from the monitoring device 12 through the first communication network 14. Using the operation data received by the first server-side communication unit 25, the reproduction unit 27 reproduces, based on the working model of the elevator, working data indicating a situation of working of the elevator during the operation indicated by the operation data. Using the working data reproduced by the reproduction unit 27, the evaluation unit 28 evaluates, based on the deterioration factor model of equipment of the elevator, a deterioration factor affecting deterioration of the equipment during the operation indicated by the operation data. Using the deterioration factor of the equipment of the elevator evaluated by the evaluation unit 28, the judgment unit 29 judges the remaining lifespan of the equipment, based on the lifespan model of the equipment.

With such a configuration, operation data that is smaller in quantity is communicated between the monitoring device 12 on the facility 2 side and the analysis device 13 even when the analysis device 13, which performs life evaluation on equipment of an elevator, uses working data including, for example, time-series data or the like. Since the analysis device 13 reproduces the working data by using the operation data, the life evaluation based on the detailed working data can be performed while the volume of communication through the first communication network 14 is reduced. There are some cases where management by the management system 1 covers a plurality of elevators in numbers ranging from several thousands to tens of thousands or more. In such cases as well, the management system 1 can perform practical remaining lifespan judgment more economically in terms of communication infrastructure development and maintenance, communication expenses, and the like. Since the life of each item of equipment of an elevator can be affected by a working environment, a working condition, and the like, the actual life of each item of equipment differs from the original design life thereof, in some cases. In the management system 1, an unreasonable event, such as an event in which equipment in the condition of still having a long remaining lifespan is replaced, or an event in which equipment reaches the end of life before replacement, can be prevented from occurring through the equipment remaining lifespan judgment that takes into consideration a working condition for the elevator and the like. Moreover, the analysis device 13 can reproduce detailed information, such as a high or low frequency of operations of an elevator, as working data. Thus, the analysis device 13 can evaluate a deterioration factor, such as temperature in particular, with higher accuracy, and consequently can further enhance accuracy in remaining lifespan judgment based on the deterioration factor. Furthermore, since it is possible for the analysis device 13 to perform life evaluation on a plurality of elevators by using the same types of models, such as the working model, the deterioration factor model, and the lifespan model, it is possible to perform comparison of situations, grasping of a difference, and the like between an elevator and another elevator with similar specifications.

The monitoring device 12 includes the first conversion unit 22. The first conversion unit 22 extracts information from data collected from the elevator and converts the information into the operation data. The monitoring device 12 includes the second conversion unit 23. The second conversion unit 23 resamples part of data on the working environment of the elevator observed in the facility 2, and converts the resampled data, together with the operation data, into communicable data.

With such a configuration, the monitoring device 12 can transmit, to the analysis device 13, information collected from the elevator, the environment sensor 11, and the like after conversion into a smaller quantity of data. Thus, the volume of communication through the first communication network 14 is reduced.

The data on the working environment of the elevator includes data on at least one of temperature or humidity in the working environment of the elevator.

With such a configuration, for example, for electronic equipment or the like that can be affected by temperature, humidity, and the like, the management system 1 can take into consideration an effect of a factor external to the elevator, such as weather.

The monitoring device 12 includes the facility-side communication unit 24. The facility-side communication unit 24 transmits the operation data to the analysis device 13 at a timing or a time of day that takes into consideration at least one of a processing load on the analysis device 13 or a communication load on the first communication network 14.

With such a configuration, a decrease or the like in processing efficiency or communication efficiency due to load concentration is restrained.

The analysis device 13 includes the input information accumulation unit 26. The input information accumulation unit 26 stores the operation data received by the server-side communication unit, in an accumulating manner over the entire service duration since the elevator service started. The input information accumulation unit 26 may store the data on the working environment received by the server-side communication unit, in an accumulating manner over the entire service duration since the elevator service started.

With such a configuration, when the working model, the deterioration factor model, or the lifespan model is updated, the analysis device 13 can retroactively reperform reproduction of the working data, evaluation of the deterioration factor, judgment of the remaining lifespan, and the like. Moreover, the operation data that is smaller in quantity than the working data is accumulated, whereby a required memory capacity can be reduced. Thus, flexibility of the management system 1 for elevators is enhanced.

The analysis device 13 is connected to the second communication network 16. The second communication network 16 is a communication network through which the specifications database 18 and the maintenance database 19 are accessible. The specifications database 18 is a database that stores the specifications information on the elevator. The maintenance database 19 is a database that stores the maintenance information on the elevator.

With such a configuration, the analysis device 13 can perform the remaining lifespan judgment or the like, with the specifications information on the elevator taken into consideration. Moreover, the analysis device 13 can make a result of the remaining lifespan judgment or the like reflected in the maintenance information on the elevator.

The analysis device 13 allows a permitted user who is allowed to access the second communication network 16 to access a result of judgment of the remaining lifespan by the judgment unit 29.

With such a configuration, since the permitted user, such as personnel in charge of maintenance, can directly refer to the result of judgment of the remaining lifespan, formulation of a maintenance plan or the like for an assigned elevator or the like is facilitated.

The analysis device 13 allows a permitted user who is allowed to access the second communication network 16 to perform a model update with regard to at least one of the working model that is used by the reproduction unit 27, the deterioration factor model that is used by the evaluation unit 28, and the lifespan model that is used by the judgment unit 29.

With such a configuration, since it is possible for the analysis device 13 to perform the remaining lifespan judge or the like based on a model that reflects the latest knowledge or the like, the remaining lifespan judgment can be performed with higher accuracy.

The analysis device 13 includes the lifespan information accumulation unit 30. The lifespan information accumulation unit 30 stores information on the remaining lifespan judged by the judgment unit 29, in an accumulating manner over the entire service duration since the elevator service started.

With such a configuration, the analysis device 13 can use accumulated history or the like of remaining lifespan judgment results to formulate a maintenance plan, provide assistance in formulating a maintenance plan, or the like.

Note that the analysis device 13 may include a plurality of server devices 15. Any one or some of the server devices 15 are located in a first country. At the time, the other or any of the others of the server devices 15 may be located in a second country that is a country or a region different from the first country.

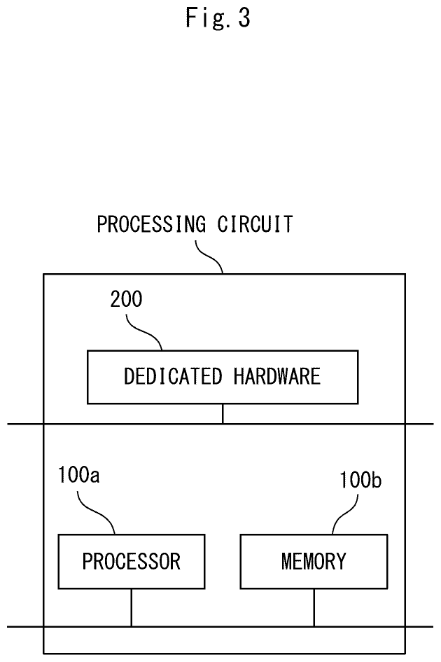

Subsequently, an example of a hardware configuration of the management system 1 is described, using FIG. 3.

FIG. 3 is a hardware configuration diagram of main parts of the management system 1 according to Embodiment 1.

Each function of the management system 1 can be implemented by processing circuitry. The processing circuitry includes at least one processor 100a and at least one memory 100b. The processing circuitry may include at least one piece of dedicated hardware 200 in addition to, or in place of, the processor 100a and the memory 100b.

When the processing circuitry includes the processor 100a and the memory 100b, each function of the management system 1 is implemented by software, firmware, or a combination of software and firmware. At least one of the software and the firmware is described as a program. The program is stored in the memory 100b. The processor 100a implements each function of the management system 1 by reading and executing the program stored in the memory 100b.

The processor 100a is also referred to as a CPU (Central Processing Unit), a processing device, an arithmetic operation device, a microprocessor, a microcomputer, or a DSP. The memory 100b is configured by using a non-volatile or volatile semiconductor memory or the like, such as a RAM, a ROM, a flash memory, an EPROM, or an EEPROM.

When the processing circuitry includes the dedicated hardware 200, the processing circuitry is implemented by, for example, a single circuit, a composite circuit, a programmed processor, a parallel-programmed processor, an ASIC, an FPGA, or a combination of any thereof.

Each function of the management system 1 can be implemented individually by the processing circuitry. Alternatively, the functions of the management system 1 can also be implemented collectively by the processing circuitry. Of the functions of the management system 1, some part may be implemented by the dedicated hardware 200, and the other part may be implemented by the software or the firmware. As described above, the processing circuitry implements each function of the management system 1 by using the dedicated hardware 200, the software, the firmware, or a combination of any thereof.

### INDUSTRIAL APPLICABILITY

The management system according to the present disclosure is applicable to elevator management.

Reference Signs List

1 Management system, 2 Facility, 3 Hoistway, 4 Traction machine, 5 Main
rope, 6 Car, 7 Counterweight, 8 Control device, 9 Car door, 10 Load weighing
device, 11 Environment sensor, 12 Monitoring device, 13 Analysis device, 14
First communication network, 15 Server device, 16 Second communication network,
17a Head office, 17b Branch office, 17c Local office, 17d Sales office, 17e
Factory, 18 Specifications database, 19 Maintenance database, 20 Collection unit,
21 Temporary memory unit, 22 First conversion unit, 23 Second conversion unit, 24
Facility-side communication unit, 25 First server-side communication unit, 26 Input
information accumulation unit, 27 Reproduction unit, 28 Evaluation unit, 29
Judgment unit, 30 Lifespan information accumulation unit, 31 Second server-side
communication unit, 100a Processor, 100b Memory, 200 Dedicated hardware

1. A management system comprising:
an elevator situation monitor that is installed in a facility to which an elevator is applied; and
an analyzer connected to the monitoring device elevator situation monitor through a first communication network, wherein
the elevator situation monitor includes first processing circuitry
to monitor a situation of the elevator, and
the analyzer includes second processing circuitry
to receive operation data from the elevator situation monitor through the first communication network, the operation data indicating a situation of an operation of the elevator,
to reproduce working data based on a working model of the elevator by using the operation data received by the second processing circuitry, the working data indicating a situation of working of the elevator during the operation indicated by the operation data;
to evaluate a deterioration factor based on a deterioration factor model of equipment of the elevator by using the working data reproduced by the second processing circuitry, the deterioration factor affecting deterioration of the equipment during the operation indicated by the operation data; and
to judge a remaining lifespan of the equipment of the elevator based on a lifespan model of the equipment by using the deterioration factor of the equipment evaluated by the second processing circuitry.

2. The management system according to claim 1, wherein the first processing circuitry extracts information from data collected from the elevator and converts the information into the operation data.

3. The management system according to claim 1, wherein the first processing circuitry resamples part of data on a working environment of the elevator observed in the facility and converts the resampled data, together with the operation data, into communicable data.

4. The management system according to claim 3, wherein the data on the working environment of the elevator includes data on at least one of temperature or humidity in the working environment of the elevator.

5. The management system according to claim 1, wherein the first processing circuitry transmits the operation data to the analyzer at a timing or a time of day that takes into consideration at least one of a processing load on the analyzer or a communication load on the first communication network.

6. The management system according to claim 1, wherein
the analyzer includes a plurality of server computers including a first server and a second server,
the first server is located in a first country, and
the second server is located in a second country that is different from the first country.

7. The management system according to claim 1, wherein the second processing circuitry stores information on the remaining lifespan judged by the second processing circuitry, in an accumulating manner over an entire service duration since an elevator service of the elevator started.

8. The management system according to claim 1, wherein the second processing circuitry stores the operation data received by the second processing circuitry, in an accumulating manner over an entire service duration since an elevator service of the elevator started.

9. The management system according to claim 1, wherein the analyzer is connected to a second communication network through which a specifications database and a maintenance database are accessible, the specifications database storing specifications information on the elevator, the maintenance database storing maintenance information on the elevator.

10. The management system according to claim 9, wherein the analyzer allows a permitted user who is allowed to access the second communication network to access a result of judgment of the remaining lifespan by the second processing circuit.

11. The management system according to claim 9, wherein the analyzer allows a permitted user who is allowed to access the second communication network to perform a model update with regard to at least any one of the working model that is used by the second processing circuitry, the deterioration factor model that is used by the second processing circuitry, and the lifespan model that is used by the second processing circuitry.
